(19) United States
(12) Patent Application Publication
(10) Pub. No.: US 2019/0155261 A1
(43) Pub. Date: May 23, 2019

(54) SMART NODE FOR A DISTRIBUTED MESH NETWORK

(71) Applicant: ATOS WORLDGRID, Bezons (FR)

(72) Inventors: Lionel BOUZON, St Pierre d`Allevard (FR); Lionel DEBROUX, St Etienne de Sainte Geoirs (FR); Charles EYNARD, Grenoble (FR); Christophe VOISIN, Le Sappey en Chartreuse (FR); Vincent DIMITRIOU, Champ-sur-Drac (FR)

(21) Appl. No.: 16/081,726

(22) PCT Filed: Mar. 1, 2017
(86) PCT No.: PCT/EP2017/054836

§ 371 Date: Jan. 22, 2019

(30) Foreign Application Priority Data
Mar. 1, 2016 (FR) 1651726

(51) Int. Cl. G05B 19/418; G06F 8/65; G06F 9/4401

(52) U.S. Cl. CPC G05B 19/41855; G05B 2219/33139; G06F 9/4401; G06F 8/65

(57) ABSTRACT

The invention relates to a smart node for a distributed mesh network, each node allowing two-way communication with other nodes or a central platform, and each node comprising a Linux or Linux-compatible computer hardware architecture and a software stack having a small footprint and low consumption of resources, using an object-oriented programming language to implement, by execution on the hardware architecture, the deployment of multiple nodes by neighborhood and critical mass effect, each node being iso-functional and capable of communicating with its neighbor, storing and managing an object, and receiving an execute statement from a program of another node in the mesh, said program associating a node-specific identifier and a neighborhood identifier with the communication module of each node.

### TECHNICAL FIELD OF THE INVENTION

The present invention relates to a smart node for a distributed mesh network and, more specifically to its use in the field of storage, distributed processing and the exploitation of big data.

### TECHNOLOGICAL BACKGROUND OF THE INVENTION

An industrial production line generally comprises multiple steps involving various actors or various entities. Each actor produces data, and very often these are managed locally. For example, in the case of the water treatment process and the exploitation of the resources from the treatment, a waste water treatment plant locally controls the industrial processes using practice and running experience local to the site considered (monitoring, control). On the data level, the site (plant) evolves in isolation with, in particular, no interface on the regional (territory) or global (networks and national resources) level.

Pooling these various sources of information (local, regional, and global sources) is, however, necessary since they would ensure the possibility of comparing, exchanging and exploiting data with the object of reducing the ecological footprint and operating costs. The benefit of such an approach centers on the global optimization of the industrial process and may be both environmental and economic.

One solution for establishing an interface between the various entities of the industrial process and a much broader communication ecosystem would be to use standard client/server architectures making use of installing virtual private networks (VPN).

However, setting up a VPN would lead to excessive latencies and costs since deployments could involve a multitude of sites and different entities.

Application TW201445929 (A) corresponding to application EP2809034 teaches the use of nodes in a smart mesh network. The nodes then act as an interface between the entities of the network. This document teaches a method for setting up a smart architecture cell mesh (SACM) network by a procedure consisting in: deploying a plurality of mesh nodes, wherein each of the mesh vertices has an ability to communicate with the other nodes of the mesh and a gateway capability for providing access to a service network, wherein the service network provides a wireless communication service; and consisting in establishing a plurality of links between the mesh nodes, each of the links connecting two of the mesh nodes; the search and selection of a plurality of dynamic gateway nodes from the plurality of nodes of the mesh and establishing a plurality of connections between the dynamic gateway nodes and the service network, and performing routing and path optimization to find the optimal route paths for all the nodes of the mesh accessing the service network.

Only the vertices of the mesh have an ability to communicate with the other nodes of the mesh, and the procedure requires a search and a selection of the nodes for optimizing the mesh.

This requires a complex implementation and does not allow easy upgrading of the network.

### GENERAL DESCRIPTION OF THE INVENTION

The object of the present invention is to overcome some drawbacks of the prior art by providing the ability to interconnect a much broader data ecosystem making it possible to take into account an upgrade dimension in keeping with the number of sites and the type of applications.

This object is achieved by a smart node for a distributed mesh network, each node allowing two-way communication with other nodes or a central platform and each node comprising a computer hardware architecture and a software stack, the node being characterized in that the execution of said software stack on the computer hardware architecture implements a set of functionalities comprising at least the following functionalities:
creating and managing, for itself or the other nodes of the mesh, objects adapted to industrial processes so as to control any type of process, the set of objects defined for the whole mesh and known to each of the nodes being referred to as a “object dictionary”;
storing and managing at least one object by each node for maintaining the current status of the object and using a stored list of neighborhoods of the nodes to which it itself is connected, for informing each neighboring node of the possible change of status of the object;
associating, with the communication module of each node, an identifier specific to the node and a neighborhood identifier, for making each node isofunctional and capable of receiving an execution order from a program of another node of the mesh.

According to another feature, the set of functionalities includes the functionalities of booting and communication of each node via a communication module, in its immediate neighborhood thanks to a configuration with a minimum range of functionalities, of deployment of multiple nodes in a distributed mesh by critical mass and neighborhood effect and consisting in optimizing, by means of an algorithm executed on the hardware architecture, the number of smart nodes to be deployed and the number of their interconnections via neighborhoods for achieving the availability, robustness of deployment and the continuity of service required by the quality of service of a specific service.

According to another feature, the systematic diffusion of data or commands takes place by configuration of the diffusion module of the node (1) [Smart Node], this diffusion module being initially configured for implementing, by execution on the computer hardware architecture, a functionality of diffusion, within the network (8), of a variable or a given group of variables with a given resolution and to a given depth in the mesh, e.g. 3 or 4 levels of neighborhoods.

According to another feature, the smart node comprises a node manager managing the dynamic deployment of new functionalities and functionalities implemented by the software modules, executed on the computer hardware architecture, by monitoring and controlling the rebooting and security updates of a software module that would stop or die.

According to another feature, each object belongs to at least one class which is a description of the characteristics of one or more objects representative of an industrial process or of a business characteristic, each object is created from this class and forms an instance of the class in question, the characteristics and the status of an object are handled by methods incorporated in the smart node (1), the status of an object corresponds to the information stored at a given instant, as described by the values of the set of its properties, also referred to as fields or attributes.

According to another feature, each node comprises a device including at least one software layer, said software layer implementing, by execution on the computer hardware architecture, a functionality of storing, in addition to information from the process sensors, an attribute indicating that the node concerned is a parent of the object, referred to as a “parent node”.

According to another feature, each node comprises a device including at least one software layer, said software layer implementing, by execution on the computer hardware architecture, a functionality for informing each node (1) in its neighborhood so that the neighboring nodes (1) inform the other nodes (1) following a path oriented in a direction that depends on the topology or specific architecture of the mesh, defining the links between the nodes of the network, and if necessary following a path oriented toward a central platform (10) or toward the processes (7a, 7b), each node (1), thus informing the rest of the mesh and each node (1) thus storing the object, its current status and parent node (1) to which the object is assigned.

According to another feature, the functionalities implemented by the node also comprise the diffusion, in the form of time series, of the data collected or calculated by each node, said diffusion being performed by the association of two data diffusion modes: a “systematic” diffusion mode wherein the data are diffused with a given resolution and to a given depth in the mesh, and an “opportunistic” diffusion mode wherein at least one neighboring node of another node concerned by an initial data request, autonomously records the information or the data passing therethrough in its memory in order to rebroadcast said data or information when a similar request to the initial request is repeated.

According to another feature, each node is configured for implementing a planned functionality of systematic logging of the data, but also storing actions that take place periodically or actions relating to the “opportunistic” diffusion mode, in its memory, each node thus having the ability to behave autonomously for logging the data collected during actions taking place periodically or actions related to the “opportunistic” diffusion mode.

According to another feature, each node has at least one interface for accessing its image of the “object dictionary”, this interface being configured for defining a new node or a new object for a node, the request for modification being diffused in the mesh and transmitted from one node to another up to the parent node concerned if the modification made to the dictionary does not relate to the node from which the manager is accessed, the parent node of the object then proceeding to the execution of the request, the result of the execution then being diffused in its turn in the rest of the mesh, each node receiving this result then updating its own image of the “object dictionary”.

According to another feature, the functionalities implemented by each smart node comprise the rebroadcasting, via its diffusion module, to the rest of the mesh and at configurable time intervals, the status of its own objects, in order to compensate for any temporary or persistent break in communication in the mesh, this ability making it possible for the mesh to restore, where necessary, the integrity of the various images, associated with the various nodes in the mesh, of the “object dictionary”.

According to another feature, the objects are handled without the modifications made to the status of an object do not use the status of another object or influence this one, each object having access permission for any use or any entity of the industrial process, the attributes or definition fields of the objects being changed dynamically by the node manager.

According to another feature, each object uses a method that defines a quality parameter associated therewith, said quality parameter representing the difference between a desired target value of the status of an object and the actual status of the value, the desired status of an object being formalized by the request for modification of the status of said object, said request being formulated from any remote node even if it is not the parent node of the object, then transmitted to the mesh and from one node to another up to the parent node concerned, the execution of said request by the node concerned thus allowing each of the nodes of the mesh to retrieve the value of the actual status of an object and therefore to calculate its quality.

According to another feature, each node of the mesh or the platform comprises a device including at least one software layer, said software layer implementing, by execution on a computer hardware architecture, a functionality of connecting to any node of the mesh, by sending the identifier of the node to be modified, so as to remotely and dynamically modify the node concerned even if the user is connected to a node that is not the parent node of the object he wishes to modify.

According to another feature, the nodes are used in a universal, smart system of monitoring an industrial process comprising a central platform for mass data management for the acquisition, management and storage of a data lake and means of communication with a distributed mesh network consisting of smart nodes.

According to another feature, each node performs the following functions:
controlling process monitoring sensors or process monitoring programmable logic controllers or actuators and acquisition of the data therefrom;
data logging, formatting and decentralized calculations.

### DESCRIPTION OF THE ILLUSTRATIVE FIGURES

Other features and advantages of the present invention will appear more clearly on reading the following description, made with reference to the appended drawings, in which:

FIG. 1 represents a diagram of the architecture of the smart node according to a first embodiment,

FIG. 2 represents an operating diagram of the smart node according to a second embodiment.

### DESCRIPTION OF PREFERRED EMBODIMENTS OF THE INVENTION

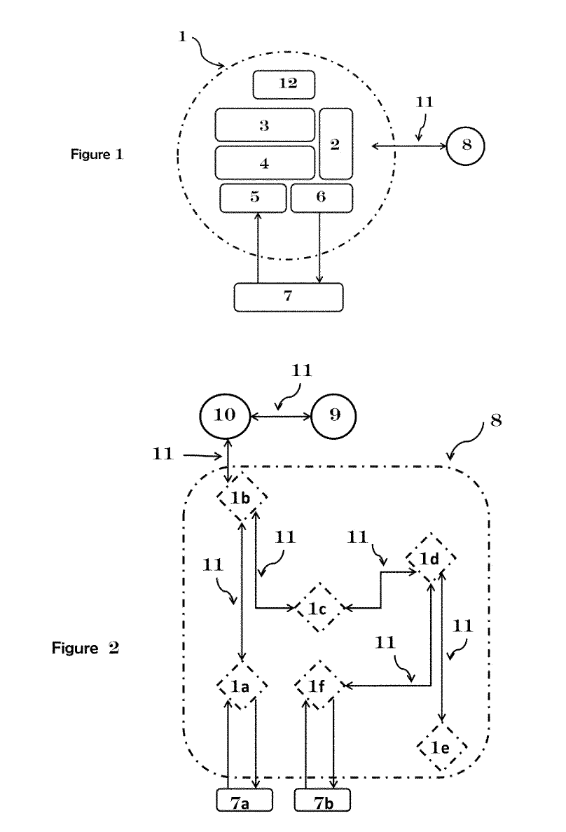

The present invention relates to a Smart Node (1, FIG. 1) for constituting with other nodes a distributed mesh network (8) as represented in FIG. 2.

In some embodiments, the smart node (1) comprises a computer hardware architecture and a small footprint (10 to 300 Mbytes) software stack (2, 3, 4, 5, 6), with low resource consumption running on the hardware architecture. Said architecture being hardened (not shown), of an X86 type or ARM Raspberry or MIPS type, energy—efficient and resistant to severe environmental conditions (shocks and vibration, temperature from—40° C. to +80° C.) running under a LINUX operating system or similar.

A Smart Node (1) will conform to a microservices type of architecture. It comprises a backbone around which the Node Manager is built. Said node manager is programmed for dynamically activating, on demand, a range or set of functionalities among the following categories:
Acquisition and instrumentation capabilities (e.g. in Modbus, or Physical Signals)
Data and message logging, formatting and decentralized calculations on the data
Web dashboards for operators on the move
Gateway and Machine-To-Machine (M2M) Interoperability

In some embodiments, the systematic diffusion of data or commands takes place by configuration of the diffusion module of the node (1), this diffusion module being initially configured for implementing, by execution on the computer hardware architecture, a functionality of diffusion, within the network (8), of a variable or a given group of variables with a given resolution and to a given depth in the mesh, e.g. 3 or 4 levels of neighborhoods.

In some embodiments, an additional functionality is first implemented in the form of a module recognized by the node manager (12). Said node manager (12) thus manages the dynamic deployment of new functionalities and functionalities implemented by the software modules, executed on the computer hardware architecture, by monitoring and controlling the rebooting and security updates of a software module that would stop or die.

In some embodiments, each created and managed object belongs to at least one class which is a description of the characteristics of one or more objects representative of an industrial process, each object is created from this class and forms an instance of the class in question, the characteristics and the status of an object are handled by methods incorporated in the smart node (1) connected directly to the process, the objects of which are to be monitored and controlled. The status of an object corresponds to the information stored at a given instant, as described by the values of the set of these properties, also referred to as fields or attributes.

In some embodiments, each smart node (e.g. 1a, FIG. 2) for a distributed network comprises a piece of middleware (2) incorporating a communication agent for two-way communications (11) with other nodes (1b, 1c, 1d) or, preferably, to a central platform (10) and by the neighboring node (1d) to each neighboring node (1e) or (1f) according to need. This middleware (2) thus allows the deployment of multiple nodes in a distributed mesh network (8) by critical mass and neighborhood effect consisting in optimizing, by means of an algorithm executed on the hardware architecture, the number of smart nodes to be deployed and the number of their interconnections via neighborhoods for achieving the availability, robustness of deployment and continuity of service required by the quality of service of a specific service. Each node (1a, . . . , 1f) comprises a device including at least one software layer, the execution of said software layer on the computer hardware architecture implementing the functionalities of storing (3) and managing (4) at least one object, maintaining the status of the object at each instant referred to as the “actual status” (as opposed to the “targeted status”, the desired status) and implementing at least one method of monitoring the change in the status of the object. This method uses a stored list of neighborhoods of the nodes (e.g. 1c, 1e, 1f) to which the node (e.g. 1d) is itself connected, for informing each neighboring node of the possible change of status of the object, by the use of this list.

In some embodiments, said smart node, for example, (1a or 1f) comprises a device including at least one software layer (5, 4, 3), the execution of said software layer on the computer hardware architecture making it possible to store, thanks to a logging software layer (3), in addition to the information from the sensors of the process (7a or respectively 7b) and filling out the fields of an object assigned to this node, a representative attribute of the identifier of said node (1a or respectively 1f) and indicating that the node concerned is a parent of the object, said node being referred to as the “parent node”.

In some embodiments, the software stack (5, 6) of said node makes it possible as a result of processing performed by a processing engine (4) to send, via the software layer (6) control signals to the sensors or programmable logic controllers or actuators for monitoring a process (7a or 7b) connected to the node (1a respectively 1f) and via another software layer (5), the acquisition of the data from the sensors or actuators or programmable logic controllers of the processes (7a, 7b). Conversely the processes (7a, 7b) will be able to feed back the information via their respective neighborhood node (1a, 1f) in the neighborhood to a platform (10) then the data lake (9).

In some embodiments, each node (e.g. 1f) for informing each node in its neighborhood (e.g. 1d) comprises a device including at least one software layer, said software layer implementing, by execution on the computer hardware architecture, a functionality for informing each node (1) in its neighborhood so that the neighboring nodes (1) inform the other nodes (1) following a path oriented in a direction that depends on the topology or specific architecture of the mesh, defining the links between the nodes of the network, and if necessary following a path oriented toward a central platform (10) or toward the processes (7a, 7b), each node (1), thus informing the rest of the mesh and each node (1) thus storing the object, its current status and the parent node (1) to which the object is assigned.

The deployment of the nodes in the mesh (8) typically takes place in the following way: the software of each node (1) is factory configured with a minimum range of functionalities allowing it to boot up and communicate in its immediate neighborhood. These basic functions allow a gradual first diffusion of the characteristics of the node, namely its identifier and the objects configured. Object is understood to mean any representation of business or technical data defining a variable and/or a service. Notably the following are distinguished:
technical services: these are protocol service layers for communicating with industrial equipment (e.g. Modbus application layer, OPCUA, CanOPen, CAN);
“primary” variables: these are variables storing data gathered by the technical services;
calculation services: which are for calculating indicators and implementing the logic based on the values of the primary variables;
secondary variables: which are for storing the results of the values from the calculation services. They are therefore variables derived (by calculation) from the primary variables;
general services: these are various services (e.g. logging, printing, taking photos or videos, specific algorithm) for supplementing traditional SCADA (Supervisory Control And Data Acquisition) logic with business or media services. For example, if a vibration indicator (secondary variable) exceeds a certain threshold then 10 photos are taken in a burst by a general service and these photos are transmitted to the rest of the mesh.

The set of objects is gathered together in the “object dictionary”. The implementation of this dictionary, which is based on the use of an in—memory NoSQL database, is innovative since it is very compact and independent of a predetermined object model. The compactness of the dictionary also allows diffusion throughout the mesh (8).

Once a node (1) is first placed in service, it then becomes visible and/or accessible from any other node (1) of the mesh (8). A local graphical interface incorporated in each node then makes it possible to work on the most easily accessible node while allowing the configuration and modification of the services and functionalities of a remote smart node. The most common modifications are:
adding additional objects
modifying the diffusion policy of the data.
activating and/or installing an additional software module (e.g. the ability of the smart node to become a web server, the ability to interoperate with a new system, etc.). An additional functionality is first implemented in the form of a module recognized by the Node Manager which will therefore accordingly manage its lifecycle. A given node (1) [Smart Node] is therefore configured for operating with a certain range of modules under the supervision and control of the Node Manager. If a module is interrupted or dies, the Node Manager is responsible for rebooting it and for security updates.

One of the very innovative factors of the invention is that it is not absolutely necessary that the Smart Node on which a user is working is the one that he wishes to modify or is on the same network or in “direct IP visibility” as a client would be with a conventional server. Indeed, communication in the mesh relies on gradual communication. For example, and without limitation, a modification is made locally on node A intended for a node E. Node A shares the same neighborhood (V_{A,B}) as node B which has the neighborhood (V_{B,A}; V_{B,C}; V_{B,D}). Node B shares the same neighborhood as nodes C and D. Node D shares the same neighborhood as node E. Node B is informed of the modification made to node A for the attention of E. As this does not concern it, it merely informs its neighborhood of this, i.e. B, B then informs C and D, etc. Thus gradually the modification request arrives in the neighborhood concerned and at the node [Smart Node] concerned (E). Node E proceeds to perform the modification and if it succeeds, it informs its neighborhood that its configuration has changed. The notification of the success of the modification is thus propagated back to the rest of the mesh.

In some embodiments, the diffusion of the data collected or calculated by the smart nodes (diffusion in the form of time series) is performed by the association of two data diffusion modes: a “systematic” diffusion mode wherein the data are diffused with a given resolution and to a given depth in the mesh, and an “opportunistic” diffusion mode wherein at least one neighboring node (1) of another node (1) concerned by an initial data request, autonomously records the information or the data passing therethrough in its memory in order to rebroadcast said data or information when a similar request to the initial request is repeated, the pattern or scheme of diffusion of data diffused by the nodes (1) being different from a systematic replication scheme wherein the data diffusion scheme is identically duplicated for all the nodes.

Systematic diffusion takes place by configuration of the diffusion module of the node (1) [Smart Node], this diffusion module being initially configured for diffusing a variable or a given group of variables with a certain resolution and to a certain “depth in the mesh” e.g. 3 or 4 levels of neighborhoods. This systematic policy thus allows, at any point of the mesh, having a certain level of hypervision (not optimal with the best granularity and resolution, but all the same an overall view). Opportunistic diffusion is the ability of the mesh to respond dynamically to a question. For example, it may involve finely tracking, to the second between 2:03 pm and 2:08 pm from node A, the value of a pressure P1 acquired by node E at intervals of half a second, but diffused systematically only at an interval of 20 minutes to the third and fourth level neighborhoods to which A belongs. In this case, locally at node A, the data is not available, so this node will form a specific request to try to retrieve the requested values. The request will pass gradually, from neighborhood to neighborhood until finding a node that is able to return a time series meeting the criterion. If the question is asked for the very first time, the response will certainly be given by node E. By diffusing the response, the “opportunistic” policy consists for the other mesh nodes (8) in recording in their cache memory (in the proxy-cache sense) this fraction of time series with a very precise resolution between 2:03 p.m. 2:08 p.m. The next time that the same question is put again in the mesh (8) (this being very likely since it is certainly an epiphenomenon that may interest other users from other nodes) it will obtain a faster response since the response will already be pre-stored by a neighboring node.

In some embodiments, the nodes are isofunctional, each node receiving an execution order from a program of another node of the mesh, the execution orders being either identical, or different from one node to another. Said program also associates with the communication module of each node an identifier specific to the node and a neighborhood identifier. The communication module having its node identifier and the neighborhood identifier, transmits messages or requests to all the connections that it has had via wired or wireless means; for example, and without limitation, if the request concerns the results of a measurement, it is sent to all nodes in the neighborhood. If among the nodes of the neighborhood there is at least one in the immediate neighborhood of the transmitting node that has the results in memory, these are transferred to the node concerned. If the nodes of the neighborhood are not able to respond to the request, the request is transferred to the nodes of their respective neighborhood until the node that performed the measurements responds to it. If no node has performed any measurements, the request is transmitted to the node located in the neighborhood of the sensor responsible for making the measurements. Once these measurements have been performed, the results are transmitted from neighborhood to neighborhood up to the node transmitting the request.

In some embodiments, each node (1) is configured for implementing a planned functionality of systematic logging of the data, but also storing actions that take place periodically or actions relating to the “opportunistic” diffusion mode, in its memory, each node (1) thus having the ability to behave autonomously for logging the data collected during actions taking place periodically or actions related to the “opportunistic” diffusion mode.

Middleware (2) must be able to ensure deployment of nodes in the mesh over separate and heterogeneous networks without having to resort to the construction of a Virtual Private Network (VPN). Indeed, deployments may involve a multitude of sites and different entities. Establishing a VPN would lead to excessive latencies and costs.
Middleware (2) must also implement security functions for ensuring the confidentiality and integrity of the data exchanged both between the nodes and with the Big Data Management block.
Middleware (2) must ensure efficient two-way exchanges with the Big Data platform. It must in the first instance support the exchange of data then the distribution of precalculation services to be executed as close as possible to the field or even instances of implementing prediction services (Machine Learning) previously trained on a Big Data central platform (10).
Dashboard rendering by the smart nodes of the mesh network is also envisaged in a thin client. In the first instance they will also be generic and offer the possibility for the local user (in plant or on the move) to track the variables of his choosing.

In some embodiments, the central platform (10) comprises a device including at least one software layer, said software layer implementing, by execution on the computer hardware architecture, the functionalities of creating and managing, for itself or the other (1) nodes of the mesh, objects adapted to industrial processes so as to control any type of process. The set of objects defined for the whole of the mesh and known to each of the nodes is referred to as an “object dictionary”.

In some embodiments, each node (1) has at least one interface for accessing an image of the “object dictionary”, this interface being configured for defining a new node or a new object for a node, the request for modification being diffused in the mesh and transmitted from one node (1) to another up to the parent node concerned if the modification made to the dictionary does not relate to the node from which the manager (12) is accessed, the parent node (1) of the object then proceeding to the execution of the request, the result of the execution then being diffused in its turn in the rest of the mesh, each node (1) receiving this result then updating its own image of the “object dictionary”. This new architectural paradigm allows a real distribution of the monitoring logic ensured collectively by the mesh by eliminating the use of a single central node.

In some embodiments, the functionalities implemented by each smart node (1) comprise the rebroadcasting, via its diffusion module, to the rest of the mesh and at configurable time intervals, the status of its own objects, in order to compensate for any temporary or persistent break in communication in the mesh, this ability making it possible for the mesh to restore, where necessary, the integrity of the various images, associated with the various nodes in the mesh, of the “object dictionary”.

In some embodiments, the objects are handled without the modifications made to the status of an object do not use the status of another object or influence this one, each object having an access permission for any use or any entity of the industrial process, the attributes or definition fields of the objects being changed dynamically by the node manager (12).

In some embodiments, each object uses a method that defines a quality parameter associated with it, said quality parameter representing the difference between a desired target value of the status of an object and the actual status of the value, the desired status of an object being formalized by the request for modification of the status of said object, said request being formulated from any remote node (1) even if it is not the parent node of the object, then transmitted to the mesh and from one node (1) to another up to the parent node (1) concerned, the execution of said request by the node (1) concerned thus allowing each of the nodes (1) of the mesh to retrieve the value of the actual status of an object and therefore to calculate its quality.

In some embodiments, the nodes (1) may be used in a universal, smart system for monitoring an industrial process preferably comprising a central platform (10) for mass data management (e.g. and without limitation, Big Data Management) for the acquisition, management and storage of a data lake (9, FIG. 2) and means of communication (11) with a distributed mesh network (8) consisting of smart nodes (1a to 1f). The structuring of the monitoring logic in what is called an object dictionary makes it possible to define, using “atomic parts” (mainly services and object variables), which is generally defined as a monolithic application in the prior art of industrial monitoring systems. The set of services form what is called “monitoring intelligence”. The latter is made “transportable” thanks to the middleware (2), capable of distributing both data and “intelligence” on different nodes (1) of the network (8) thereby forming the monitoring network. The embedded engines of local services are capable of managing services of different types (not only calculations) homogeneously and irrespective of the hardware platform. The main advantage of the engines responsible for the services lies in the fact that they can run on small hardware units (resources with little CPU [Central Processing Unit] and memory).

The smart node mesh network makes it possible to deploy an industrial monitoring infrastructure for simulating or collecting and analyzing data particularly adapted to physically very spread out processes (small power plants, IoT, distribution, wind or wave farms, open field sensors, process simulation).

The smart node mesh network is an innovative software solution in the field of industrial monitoring. Its aim is to be a complement to the SCADA (Supervisory Control And Data Acquisition) systems on the market for allowing a quick and agile deployment of permanent or temporary monitoring schemes.

Unlike conventional SCADA systems based on central and very vertical server type systems, the smart node mesh network makes it possible to define a monitoring strategy carried by a set of software nodes connected via smart middleware. It is therefore possible to define a monitoring logic best fitting the process and with a very fine granularity. This granularity makes it possible inter alia to be able to define individual permissions on each of the elements of monitoring (variables, algorithms) making the smart node mesh network a multi-user but especially a multi-entity system. The atomic manipulation of the elements of monitoring also allows hot deployment and scaling of monitoring while limiting the risks of regression on the existing logic.

These software nodes can run on a wide range of hardware, notably including mobile devices (smartphones and tablets) but also embedded industrial field equipment. The smart node mesh network therefore natively introduces mobility while providing each user, regardless of their point of connection, the same quality of overall hypervision as a central system.

Finally, the smart node mesh network provides a wide range of remote deployment functionalities on the most constraining network topologies (complex routing, reduced bandwidth) and without the need to use VPN. These innovations allow a temporal decorrelation and that of the role of maintenance and scaling actions notably by eliminating the need for computer skills, PLC (Programmable Logic Controller or programmable controller) or SCADA in the field. Accordingly, the smart node mesh network is therefore a Plug and Play solution where the operationals are limited to connecting the field devices to the electrical network and the communication network. The rest of the deployment (software and monitoring logic bricks) is then provided by remote users.

The smart node mesh network is therefore particularly adapted to physically spread out industrial processes and where the costs of maintenance and scaling are an important factor.

Nevertheless, in a context of plant monitoring, the smart node mesh network also offers many advantages.

As part of renovating or upgrading existing industrial monitoring systems with the addition of software nodes, the smart node mesh network makes it possible to quickly implement advanced mobility functions throughout the plant area. The mesh construction of the solution further allows a progressive deployment open to modifications in strategy according to the initial feedback from users.

Many functionalities may also be used as part of Smart Maintenance or predictive maintenance. Additional instrumentation (sensors, hub) and analysis (tracking, logs, alarms, dashboards) may be created on the fly and in active collaboration between multiple users for the purposes of optimization of the process or setting up asset tracking (electronic documentation, QR Codes).

The smart node mesh network seen as a dynamic tool also allows the deployment of monitoring and temporary analysis strategies very much adapted to the auditing phases (energy efficiency, simulation, security and industrial safety). For this type of deployment in particular, the smart node mesh network is compatible with a wide range of wireless communication in the ISM band (169 MHz, 868 MHz, 969 MHz) and notably with SIGFOX (Ultra Narrow Band) and LoRA technology.

In some embodiments, each node (1) of the mesh or the central platform (10) comprises a device including at least one software layer, said software layer implementing, by execution on a computer hardware architecture, a functionality of connecting to any node of (1) the mesh (8), by sending the identifier of the node to be modified, so as to remotely and dynamically modify the node (1) concerned even if the user is connected to a node (1) that is not the parent node of the object he wishes to modify.

Thus the solution developed is capable of acquiring data from processing methods internal to the plant or upstream and downstream thereof in a natural environment.

On the other hand, it is also capable of integrating other data in connection with the data ecosystem and relevant to its smart, end-to-end running. These are referred to as external sources in the rest of this document (e.g. weather forecasting, trading, energy markets).

The data sources are therefore of a very varied nature. Notably there will be a need for knowing how to interface with specialized sensors in open field (SigFox or LoRA wireless link, for example), for compatibility with a range of instrumentation or industrial interoperability protocols (e.g. Modbus, OPC, OPCUA), compatibility with interoperability standards for objects or people on the move (ETSI M2M) and finally the possibility of interrogating third-party systems in the cloud (e.g. analysis and exploitation of Web content, REST API, hydrological databases, e.g. flood management in the case of a water treatment plant).

Thus, the software layer (6) for sending control signals and the software layer (5) for data acquisition, to or from the sensors or actuators or programmable controllers of processes, must cooperate with hardware allowing wireless links in addition to wired links and be compatible with a range of instrumentation or interoperability protocols for moving objects or people.

The mesh deployment of the network (8) makes it possible to create an interface with the data ecosystem at various levels of aggregation (field, vehicles, plants, regional area, global or cloud level). An architecture of this type therefore makes it possible to collect the data at the most suitable levels. The transmission of the data may therefore involve multiple nodes prior to the Big Data Management (BDM) central platform (10) being made available for being exploited.

After exploitation and creation, e.g. of relevant indicators (fields of an object) for running the process, inter-node communication may be used again, but “in the downward direction” this time for transmitting optimized instructions in the field. Here again the mesh architecture makes it possible to do away with direct communication links between the global level and the field.

The implementation of the functional layers of this global information system thus takes place with different levels of aggregation, it therefore involves not only a conventional central system but an infrastructure capable of addressing a highly distributed (sensors in a natural environment, moving vehicles or people, plants at different sites, interoperability with third-party regional systems or central systems) and highly dynamic set of problems (deployment of new services, scaling, adaptability to the availability or non-availability of parameters necessary for the hypervision or the optimization of running processes).

The present application describes various technical features and benefits with reference to the figures and/or various embodiments. The person skilled in the art will understand that the technical features of a given embodiment may, in fact, be combined with features of another embodiment unless it is explicitly mentioned otherwise or it is obvious that these features are incompatible or that the combination does not provide a solution to at least one of the technical problems mentioned in the present application. In addition, the technical features described in a given embodiment may be isolated from the other features thereof unless explicitly mentioned otherwise.

It should be obvious to persons skilled in the art that the present invention allows embodiments in many other specific forms without departing from the scope of the invention as claimed. Consequently, the present embodiments must be considered by way of illustration, but may be modified in the field defined by the scope of the attached claims, and the invention should not be limited to the details given above.

1. A smart node for a distributed mesh network, each node allowing two-way communication with other nodes or a central platform and each node comprising a computer hardware architecture and a software stack, using an object-oriented language, wherein the execution of said software stack on the computer hardware architecture implements a set of functionalities comprising at least the following functionalities:
creating and managing, for itself or the other nodes of the mesh, objects adapted to industrial processes so as to control any type of process, the set of objects defined for the whole mesh and known to each of the nodes being referred to as a “object dictionary”;
storing and managing at least one object by each node for maintaining the current status of the object and using a stored list of neighborhoods of the nodes to which it itself is connected, for informing each neighboring node of the possible change of status of the object;
associating, with the communication module of each node, an identifier specific to the node and a neighborhood identifier, for making each node isofunctional and capable of receiving an execution order from a program of another node of the mesh;

2. The smart node according to claim 1, wherein the set of functionalities includes the functionalities of booting and communication of each node via a communication module, in its immediate neighborhood thanks to a configuration with a minimum range of functionalities, of deployment of multiple nodes in a distributed mesh by critical mass and neighborhood effect and consisting in optimizing, by means of an algorithm executed on the hardware architecture, the number of smart nodes to be deployed and the number of their interconnections via neighborhoods for achieving the availability, robustness of deployment and the continuity of service required by the quality of service of a specific service.

3. The smart node according to claim 1, wherein the systematic diffusion of data or commands takes place by configuration of the diffusion module of the node [Smart Node], this diffusion module being initially configured for implementing, by execution on the computer hardware architecture, a functionality of diffusion, within the network, of a variable or a given group of variables with a given resolution and to a given depth in the mesh, e.g. 3 or 4 levels of neighborhoods.

4. The smart node according to claim 1, wherein it comprises a node manager managing the dynamic deployment of new functionalities and functionalities implemented by the software modules, executed on the computer hardware architecture, by monitoring and controlling the rebooting and security updates of a software module that would stop or die.

5. The smart node according to claim 1, wherein each object belongs to at least one class which is a description of the characteristics of one or more objects representative of an industrial process or of a business characteristic, each object being created from this class and forming an instance of the class in question, the characteristics and the status of an object being handled by methods incorporated in the smart node the status of an object corresponding to the information stored at a given instant, as described by the values of the set of its properties, also referred to as fields or attributes.

6. The smart node according to claim 1, wherein each node comprises a device including at least one software layer, said software layer implementing, by execution on the computer hardware architecture, a functionality of storing, in addition to information from the process sensors, an attribute indicating that the node concerned is a parent of the object referred to as a “parent node”.

7. The smart node (1) according to claim 1, wherein each node comprises a device including at least one software layer, said software layer implementing, by execution on the computer hardware architecture, a functionality for informing each node in its neighborhood so that the neighboring nodes inform the other nodes following a path oriented in a direction that depends on the topology or specific architecture of the mesh, defining the links between the nodes of the network, and if necessary following a path oriented toward a central platform or toward the processes, each node, thus informing the rest of the mesh and each node thus storing the object, its current status and the parent node to which the object is assigned.

8. The smart node according to claim 1, wherein said functionalities implemented by the node also comprise the diffusion in the form of time series, of the data collected or calculated by each node, said diffusion being performed by the association of two data diffusion modes: a “systematic” diffusion mode wherein the data are diffused with a given resolution and to a given depth in the mesh, and an “opportunistic” diffusion mode wherein at least one neighboring node of another node concerned by an initial data request, autonomously records the information or the data passing therethrough in its memory in order to rebroadcast said data or information when a similar request to the initial request is repeated, the pattern or scheme of diffusion of data diffused by the nodes being different from a systematic replication scheme wherein the data diffusion scheme is identically duplicated for all the nodes.

9. The smart node according to claim 1, wherein each node is configured for implementing a planned functionality, of systematic logging of the data, but also storing actions that take place periodically or actions relating to the “opportunistic” diffusion mode in its memory, each node thus having the ability to behave autonomously for logging the data collected during actions taking place periodically or actions related to the “opportunistic” diffusion mode.

10. The smart node according to claim 1, wherein each node has at least one interface for accessing an image of the “object dictionary”, this interface being configured for defining a new node or a new object for a node, the request for modification being diffused in the mesh and transmitted from one node to another up to the parent node concerned if the modification made to the dictionary does not relate to the node from which the manager is accessed, the parent node of the object then proceeding to the execution of the request, the result of the execution then being diffused in its turn in the rest of the mesh, each node receiving this result then updating its own image of the “object dictionary”.

11. The smart node according to claim 1, wherein said functionalities implemented by each smart node comprise the rebroadcasting, via its diffusion module, to the rest of the mesh and at configurable time intervals, the status of its own objects, in order to compensate for any temporary or persistent break in communication in the mesh, this ability making it possible for the mesh to restore, where necessary, the integrity of the various images, associated with the various nodes in the mesh, of the “object dictionary”.

12. The smart node as claimed in claim 1, wherein the objects are handled without the modifications made to the status of an object do not use the status of another object or influence this one, each object having an access permission for any use or any entity of the industrial process, the attributes or definition fields of the objects being changed dynamically by the node manager.

13. The smart node according to claim 1, wherein each object uses a method that defines a quality parameter associated with it, said quality parameter representing the difference between a desired target value of the status of an object and the actual status of the value, the desired status of an object being formalized by the request for modification of the status of said object, said request being formulated from any remote node even if it is not the parent node of the object, then transmitted to the mesh and from one node to another up to the parent node concerned, the execution of said request by the node concerned thus allowing each of the nodes of the mesh to retrieve the value of the actual status of an object and therefore to calculate its quality.

14. The smart node according to claim 1, wherein each node of the mesh or the central platform comprises a device including at least one software layer, said software layer implementing, by execution on a computer hardware architecture, a functionality of connecting to any node of the mesh, by sending the identifier of the node to be modified, so as to remotely and dynamically modify the node concerned even if the user is connected to a node that is not the parent node of the object he wishes to modify.

15. A set of smart nodes according to claim 1, wherein they are used in a universal, smart system of monitoring an industrial process comprising a central platform for mass data management for the acquisition, management and storage of a data lake and means of communication with a distributed mesh network consisting of smart nodes.

16. The smart node according to claim 1, wherein each node is configured to perform the following functions:
controlling process monitoring sensors or process monitoring programmable logic controllers or actuators and acquisition of the data therefrom;
data logging, formatting and decentralized calculations.
